(19) United States
(12) Patent Application Publication
(10) Pub. No.: US 2017/0282450 A1
(43) Pub. Date: Oct. 5, 2017

(54) ADDITIVE MANUFACTURING OF ENGINEERED POLYMER AND POLYMER COMPOSITES WITH PRECISELY-CONTROLLED PROPERTIES

(71) Applicant: Schmutz IP, LLC, Lawrenceville, GA (US)

(72) Inventors: Daniel Slep, Lawrenceville, GA (US); Kai Yang, Port Jefferson Station, NY (US)

(21) Appl. No.: 15/471,649

(22) Filed: Mar. 28, 2017

Related U.S. Application Data
(60) Provisional application No. 62/315,930, filed on Mar. 31, 2016.

(51) Int. Cl. B29C 67/00; B33Y 10/00

(52) U.S. Cl. CPC B29C 67/0055; B33Y 10/00

(57) ABSTRACT

Composite materials and methods of additive manufacturing are provided for producing the composite materials with precisely-controlled properties. Examples of properties that can be precisely controlled in the composite material can include the hardness, tensile strength, elongation at break, Young's modulus, electrical conductivity, thermal conductivity, flame retardancy, security (tagging), or a combination thereof. In various aspects the methods can include printing amounts of two or more curable liquids from a multichannel piezo head device to form a layer that can be cured by applying a wavelength of light from a light source. By repeating, layer by layer, the process can be used for the additive manufacture of a wide variety of materials having precisely-controlled properties. The properties can be precisely-controlled by varying the amounts of the curable liquids in each layer and/or the pattern of the curable liquids in each layer.

### CROSS-REFERENCE TO RELATED APPLICATIONS

This application claims the benefit of and priority to U.S. Provisional Application Ser. No. 62/315,930, having the title “ADDITIVE MANUFACTURING OF ENGINEERED POLYMER AND POLYMER COMPOSITES WITH PRECISELY-CONTROLLED PROPERTIES,” filed on Mar. 31, 2016, the disclosure of which is incorporated herein in by reference in its entirety.

### FIELD OF THE DISCLOSURE

The present disclosure is generally in the field of methods of additive manufacturing, especially for additive manufacturing of materials and devices with controllable properties.

### SUMMARY

Methods of additive manufacturing are provided for producing composite materials with precisely-controlled properties. Some examples of properties that can be precisely controlled in the composite material can include the hardness, tensile strength, elongation at break, Young's modulus, electrical conductivity, thermal conductivity, flame retardancy, security (tagging), or a combination thereof. The methods can include printing amounts of two or more curable liquids from a multichannel piezo head device to form a layer that can be cured by applying a wavelength of light from a light source. By repeating, layer by layer, the process can be used for the additive manufacture of a wide variety of materials having precisely-controlled properties. The properties can be precisely-controlled by varying the amounts of the curable liquids in each layer and/or the pattern of the curable liquids in each layer.

A variety of properties can be precisely-controlled in the composite materials. In various aspects, a hard curable liquid and a soft curable liquid (as described in more detail below) are used to print the layer, and the precisely-controlled property is the tensile strength, elongation at break, and/or Young's modulus of the composite material. In some aspects, one of the curable liquids is a conductive curable liquid and the precisely-controlled property is the electrical conductivity of the composite material. Some aspects demonstrate use of a highly thermally resistant curable liquid and the precisely-controlled property is the thermal conductivity of the composite material. One of the curable liquids can be a detectable curable liquid, and the precisely-controlled property is the tagging of (ability to detect) the composite material. In various aspects, a flame-retardant curable liquid is used, and the precisely-controlled property is the flame retardancy of the composite material.

The properties can be precisely-controlled by varying the amounts of the curable liquids in each layer and/or the pattern of the curable liquids in each layer. In various aspects, the layer contains about 30-70 wt % of the curable liquids based upon the weight of the layer. The amount of each curable liquid can vary across the layer, e.g. across the plane of the layer (x and/or y direction, the x and y directions being horizontally across the plane of the layer) or vertically within the layer (z direction perpendicular to the x and y directions forming the plane of the layer). For example, the relative amount (w/w) of the first curable liquid to the amount of the second curable liquid can vary across the layer. The layer can be a sandwich structure of a first curable liquid and a second curable liquid. The layer can have a first portion of a first curable liquid and, adjacent to the first portion, a second portion of a second curable liquid. The layer can have an overprinting of one curable liquid on a different curable liquid, e.g. the printing can include printing a layer of a first curable liquid and an overprinting of a second curable liquid with an overprint nozzle count of about 30% to about 85%. The printing can include printing a pattern of the curable liquids to create a pattern in the layer, e.g. to create a 3-dimensional network of the first curable liquid and the second curable liquid to produce the precisely-controlled property of the composite material.

One or both of the curable liquids can contain organic or inorganic nanoparticles. Examples of nanoparticles that can be used in some aspects include a carbon nanotube, a fullerene, a graphene nanoparticle, a polyaniline nanoparticle, a metal nanoparticle, a metal oxide nanoparticle, a metal chalcogenide nanoparticle, a metal hydroxide nanoparticle, a semiconductor nanoparticle, or a combination thereof. One or both of the curable liquids can include one or more cross-linkable monomers or oligomers and a photo-initiator. In some aspects, the cross-linkable monomers or oligomers in the curable liquid(s) can be present in a combined amount from about 70-98 wt % based upon the total weight of the first curable liquid. In some aspects, the photo-initiator in the curable liquid(s) can be present in an amount from about 1-5 wt % based upon the total weight of the first curable liquid.

In an embodiment, a method for additive manufacturing of a composite material having a precisely-controlled property is provided. The method can comprise: (1) printing an amount of a first curable liquid from a first channel of a multichannel piezo head device and an amount of a second curable liquid from a second channel of the multichannel piezo head device to form a layer, (2) applying a wavelength of light from a light source to the layer to cure the first curable liquid and the second curable liquid; and (3) repeating steps (1) and (2) to form the composite material, wherein the amount of the first curable liquid and the amount of the second curable liquid in each layer is adjusted to produce the precisely-controlled property of the composite material.

In any one or more aspects of the method, the first curable liquid can be a hard curable liquid and the second curable liquid can be a soft curable liquid, and wherein the precisely-controlled property can be the tensile strength, elongation at break, or Young's modulus of the composite material. The first curable liquid can be a conductive curable liquid and the precisely-controlled property can be the conductivity of the composite material. The first curable liquid can be a thermally insulating curable liquid and the precisely-controlled property can be the thermal insulation of the composite material. The first curable liquid can be a detectable curable liquid and the precisely-controlled property can be the tagging of the composite material. The first curable liquid can be a flame-retardant curable liquid and the precisely-controlled property can be the flame retardancy of the composite material. The layer can comprise about 30-70 wt % of the first curable liquid and about 30-70% of the second curable liquid based upon the weight of the layer. The ratio of the amount of the first curable liquid to the amount of the second curable liquid can vary across the layer. The layer can comprise a sandwich structure of the first curable liquid and the second curable liquid. The layer can comprise a first portion consisting of the first curable liquid adjacent to a second portion consisting of the second curable liquid.

In any one or more aspects of the method, the step (1) can comprise printing a layer of the first curable liquid and an overprinting of the second curable liquid with an overprint nozzle count of about 30% to about 85%. The step (1) can comprise printing a pattern of the first curable liquid and the second curable liquid in the layer, wherein the pattern in adjacent layers forms a 3-dimensional network of the first curable liquid and the second curable liquid to produce the precisely-controlled property of the composite material. The first curable liquid, the second curable liquid, or both can comprise a nanoparticle. The nanoparticle can be selected from the group consisting of a carbon nanotube, a fullerene, a graphene nanoparticle, a polyaniline nanoparticle, a metal nanoparticle, a metal oxide nanoparticle, a metal chalcogenide nanoparticle, a metal hydroxide nanoparticle, a semiconductor nanoparticle, and a combination thereof. The first curable liquid, the second curable liquid, or both can comprise one or more cross-linkable monomers or oligomers and a photo-initiator. The cross-linkable monomers or oligomers in the first curable liquid can be present in a combined amount from about 70-98 wt % based upon the total weight of the first curable liquid. The photo-initiator in the first curable liquid can be present in an amount from about 1-5 wt % based upon the total weight of the first curable liquid.

In any one or more embodiments, composite materials with precisely-controlled properties are also provided. The composite materials can be prepared by any one or more aspects of the methods of additive manufacturing described herein. The methods can be made by additive manufacturing of two or more curable liquids. In various aspects, the composite material contains a hard curable liquid and a soft curable liquid, and the material is a structural material having a precisely-controlled tensile strength, elongation at break, and/or Young's modulus.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a diagram of an exemplary setup for additive manufacturing of a composite material.

FIG. 2 is a diagram of various methods of printing two curable liquids in a layer to produce composite materials having precisely-controlled properties.

FIG. 3 is a diagram of one embodiment of a method of printing a layer having a first curable liquid and a coating of a second curable liquid.

FIGS. 4A-4C depict various geometries of the printing of a rigid material (A) and a flexible material (B) to produce composite materials in Example 1.

### DETAILED DESCRIPTION

Methods of additive manufacturing of composite materials with precisely-controlled properties are provided. The methods can be used for the additive manufacturing of a variety of materials and devices with precisely-controlled structural, optical, electrical, thermal, or other properties. Although various embodiments are described herein, those embodiments are mere exemplary implementations of the methods and products produced therefrom. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Methods of Additive Manufacturing

Methods of additive manufacturing of a composite material with precisely-controlled properties are provided. The methods can be used for the additive manufacturing of a variety of objects. The methods can be used to print an object with enhanced materials strength for durability and/or with precisely-controlled mechanical, optical or electronic properties. Two or more curable liquids can be printed in precisely-controlled amounts to precisely control the properties of the composite material in a layer-by-layer fashion. For example, by controlling the mixing of 2, 3, 4, or more different curable liquids during the printing the properties of the cured object can be precisely controlled in all directions.

The methods can include printing onto a variety of substrates to produce the composite material. In some embodiments the composite material is removed from the substrate after fabrication. The substrate can have a non-stick surface to prevent adhesion of the composite material to the substrate. The substrate can be, for example, a paper, glass, polymer, metal, silicone, or ceramic substrate.

The properties of the composite material can be precisely controlled by changing the amount of each curable liquid and/or the pattern of each curable liquid within a given layer and/or in a layer-by-layer fashion. The curable liquids can be printed using a device having multiple heads, for example a multichannel piezo inkjet head. The heads may be adjusted to alter the droplet size and/or relative amounts of the curable liquids contained in the droplets. The amount of the curable liquid in a layer can be about 10 wt % to about 30 wt %, about 30 wt % to about 70 wt %, about 35 wt % to about 65 wt %, about 40 wt % to about 60 wt %, or about 70 wt % to about 90 wt % based upon the weight of the layer. The layer can be printed with one curable liquid overprinted on another curable liquid. The overprint nozzle count can be about 30% to 85%, about 35% to 80%, about 40% to 70%, about 45% to 65%, or about 55% of total nozzles. In various aspects, the methods include printing a layer of the first curable liquid and an overprinting of the second curable liquid.

The curable liquid droplets can be projected onto adjacent locations on the substrate or layer so that consecutive droplets are adjoining. Such adjacent deposition preferably results in a continuous layer or film, and also tends to facilitate blending. Various droplet sizes and size distributions can be used. Droplet size is preferably selected to provide the desired gradation of properties in the resulting printed object. For example, smaller droplets tend to produce finer spatial resolution and finer control of material properties. The volume of the curable liquid droplet can be from about 3 to 5 picoliters up to about 100 picoliters and anywhere there between.

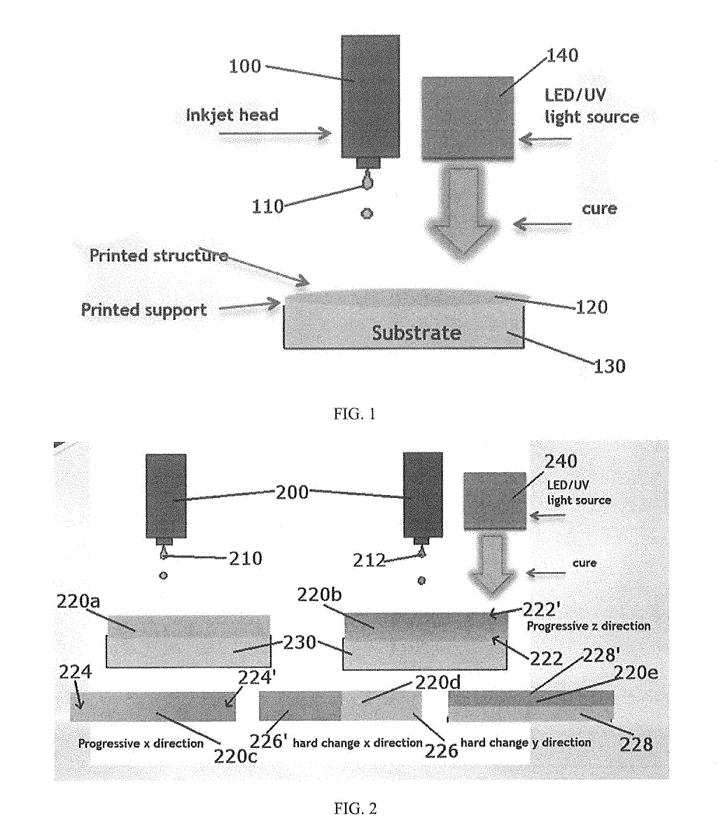

The methods can include applying a wavelength of light from a light source to the layer to cure the curable liquids. For example, when printing with a first curable liquid and a second curable liquid, a wavelength of light can be applied to cure the first curable liquid and the second curable liquid. Although it is described that ultraviolet light is used to cure the material composition of the present invention used therein, it is envisioned to use other energy sources, including infrared (IR) radiation. The light source can include any suitable source capable of providing the desired wavelength of light. Examples of a suitable light source can include a bulb or lamp, a laser, or a light emitting diode (LED). FIG. 1 depicts an example setup of a piezo inkjet head 100 that can be used to print one or more curable liquids 110 to produce a layer 120 on a substrate 130. A wavelength of light from a light source 140 can be applied to the layer 120 to cure the curable liquid 110 in the layer 120.

The curable liquids can be printed with a variety of amounts and patterns to precisely-control the properties of the composite material, see e.g. FIG. 2. A multichannel piezo head 200 can be used to print a first curable liquid 210 and a second curable liquid 212 to form a layer (220a-220e) on a substrate 230. The relative amount of the first curable liquid 210 and the second curable liquid 212 can vary across the layer (220b-220c). For example, the layer 220b can include a first portion 222 rich in the first curable liquid 210 and a second portion 222′ rich in the second curable liquid 212, where the relative amount of the first curable liquid 210 and the second curable liquid 212 varies progressively in the direction perpendicular to the layer (z direction). The layer 220c can include a first portion 224 rich in the first curable liquid 210 and a second portion 224′ rich in the second curable liquid 212, where the relative amount of the first curable liquid 210 and the second curable liquid 212 varies across the plane of the layer (e.g. in the x and/or y direction). The layer 220d can include a first portion 226 containing the first curable liquid 210 and a second portion 226′ containing the second curable liquid 212, where the first portion 226 is adjacent to the second portion 226′ in the plane of the layer (e.g. in the x and/or y direction). The layer 220e can include a first portion 228 containing the first curable liquid 210 and a second portion 228′ containing the second curable liquid 212, where the first portion 228 is adjacent to the second portion 228′ in the direction perpendicular to the layer (z direction). The first curable liquid 210 and the second curable liquid 212 can be cured with the light source 240.

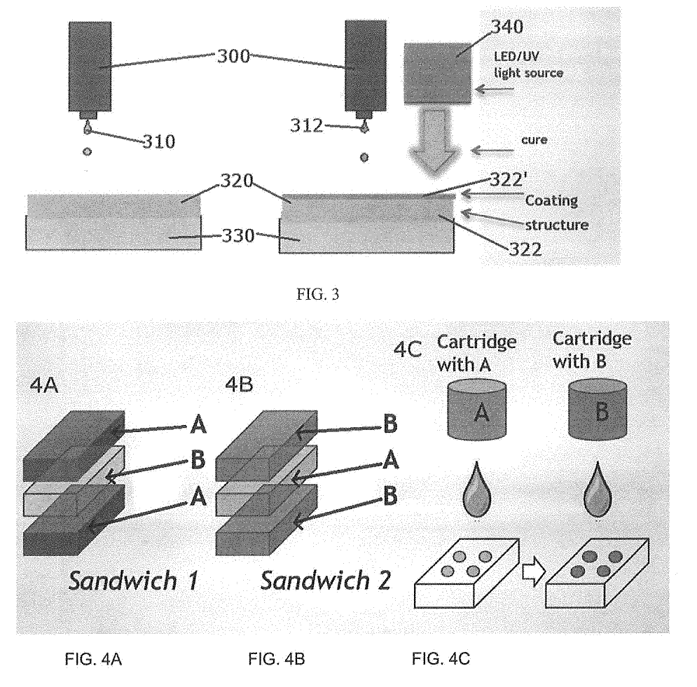

In some aspects the layer 320 can include a coating structure 322′ of the second printable liquid 312 on the first curable liquid 310 (see FIG. 3). The first curable fluid 310 can be printed on a substrate 330 and the second printable fluid 312 can be printed to provide the layer 320 having a portion 322 of the first curable liquid 310 and a coating 322′ of the second curable liquid 312. The layer 320 can be cured with a wavelength of light from the light source 340.

Curable Liquids

The curable liquid can be a hard curable liquid. A hard curable liquid, as used herein, is used as a relative term comparing the hardness of the cured liquid in comparison to the hardness exhibited by the other curable liquids in the composite material when cured. A hard curable liquid has a hardness (when cured) that is greater than the hardness of the other curable liquids in the composite material when cured. In various aspects, the hardness of a hard curable liquid can be about 70-85 HA when cured. Exemplary hard curable liquids can include curable acrylates, esters, and epoxies. The hard curable liquid can contain organic or inorganic nanoparticles.

The curable liquid can be a soft curable liquid. A soft curable liquid, as used herein, is used as a relative term comparing the hardness of the cured liquid in comparison to the hardness exhibited by the other curable liquids, in particular the hard curable liquid, in the composite material when cured. A soft curable liquid has a hardness (when cured) that is less than the hardness of the other curable liquids in the composite material when cured. The hardness of a soft curable liquid can be about 25-30 HA when cured. Exemplary soft curable liquids can include curable urethanes, acrylates, and silanes. The soft curable liquid can contain organic or inorganic nanoparticles.

The curable liquid can be an electrically conductive curable liquid. An electrically conductive curable liquid, also referred to as a conductive curable liquid, is used to refer to a curable liquid that has an electrical conductivity. In various aspects, the electrically conductive curable liquid can have an electrical conductivity of about 40 mOhms/sq or more when cured. The conductive curable liquid can include cross-linkable monomers and/or oligomers and metal nanoparticles, e.g. silver nanoparticles. The conductive curable liquid can be printed in an amount of precisely control the conductivity of the composite material.

The curable liquid can be a thermally insulating curable liquid. A thermally insulating curable liquid, also referred to as an insulating curable liquid, is used to refer to a curable liquid that has a thermal conductivity. In various aspects, the thermally insulating curable liquid can have a thermal conductivity of less than about 2.0 W/(m·K). The insulating curable liquid can be printed in an amount of precisely control the thermal conductivity of the composite material.

The curable liquid can be a detectable curable liquid. A detectable curable liquid refers to a curable liquid that, when cured, can be detected in the composite material by optical means. For example, the curable liquid can be detected by infrared (IR) spectroscopy. In some aspects, the detectable curable liquid can contain specific monomer units detectable by spectroscopy.

The curable liquid can be a flame-retardant curable liquid. Flame-retardant curable liquids refer to curable liquids that have a flame retardant rating UL-94 V-0 or more when cured. In some embodiments, a flame retardant curable liquid contains graphene nanoparticles.

The curable liquid can contain one or more cross-linkable monomers. For example, the curable liquid can contain 2, 3, 4, 5, or more different cross-linkable monomers. The term “monomer”, as used herein, generally refers to an organic molecule that is less than 2,000 g/mol in molecular weight, less than 1,500 g/mol, less than 1,000 g/mol, less than 800 g/mol, or less than 500 g/mol. Monomers are non-polymeric and/or non-oligomeric.

The cross-linkable monomers will generally contain one or more reactive functional groups that can be reacted to form the cross-linked structure upon curing. In some embodiments the cross-linkable monomers are acrylates. The cross-linkable monomers can be monoacrylates, diacrylates, or higher acrylates that can be either substituted or unsubstituted. The cross-linkable monomers can be present in a combined amount of about 70-98 wt %, 75-95 wt %, 80-95 wt %, 80-90 wt %, or 82-97 wt % based upon the total weight of the curable nano-composite.

The curable liquid can contain one or more monoacrylates. Suitable monoacrylates can include, for example, 2-[2-(Vinyloxy)ethoxy]ethyl acrylate, 2-hydroxyethyl methacrylate, isodecyl acrylate, cyanoethyl methacrylate, hydroxypropyl methacrylate, p-dimethylaminoethyl methacrylate, and cyclohexyl methacrylate. The monoacrylate can be an acrylate ester of an aliphatic alcohol that can be a cycloaliphatic alcohol or a long-chain aliphatic alcohol. In some embodiments the monoacrylate is an acrylate ester of a substituted or unsubstituted alcohol having from 2-50, 5-40, 8-30, or 8-22 carbon atoms. In some embodiments the monoacrylates are present in a combined amount of about 70-98 wt %, 75-95 wt %, 80-95 wt %, 80-90 wt %, or 82-97 wt % based upon the total weight of the curable liquid. In some embodiments the monoacrylates are present in a combined amount of about 30-60 wt %, about 35-50 wt %, or about 35-45 wt %.

The curable liquid can contain one or more higher acrylates, e.g. diacrylates or triacrylates. Suitable diacrylates can include 1,4-butanediol diacrylate, 1,6-hexanediol diacrylate, neopentylglycol diacrylate, diethyleneglycol diacrylate, tetraethylene glycol diacrylate, tripropyleneglycol diacrylate, and dianol diacrylate. The diacrylate can include the acrylic acid diester of a substituted or unsubstituted di-alcohol having from 2-50, 5-40, 8-30, or 8-22 carbon atoms. Suitable triacrylates can include trimethylolpropane triacrylate, 3eo, 3po, and 5eo. In some embodiments, the diacrylates and triacrylates can be present in a combined amount of about 10-50 wt %, about 15-45 wt %, or about 20-40 wt %.

The curable liquid can contain one or more oligomers. The one or more oligomers can be present without the presence of the one or more monomers, can be present in combination with the one or more monomers or can be optional and not present at all. The term “oligomer” is used to refer to molecules having less than about 1,000 monomer repeat units, typically less than about 500, less than about 200, less than about 100 repeat units. In some embodiments the curable nano-composites contain 2, 3, 4, 5, or more different oligomers. In some embodiments the oligomer is a pre-polymer of one or more of the cross-linkable monomers, e.g. the oligomer can be a mono-functional or multifunctional oligomer containing from about 2 to about 100, about 2 to about 80, about 2 to about 60, or about 5 to about 50 monomer repeat units of any cross-linkable monomer described herein. In some embodiments the oligomers include electronically conducting oligomers such as oligoacetylenes, oligophenylenes such as p-terphenyl and derivatives thereof, and oligothiophenes such as terthiophene and derivatives thereof. In some embodiments, when the curable liquid contains both monomers and oligomers, the total amount of cross-linkable monomers and oligomers can be greater than about 70 wt %, preferably greater than about 75 wt %, e.g. about 75-99 wt %, about 75-95 wt %, or about 80-90 wt %.

The curable liquid can contain one or more photo-initiators. The term “photo-initiator,” as the term is used herein, refers generally to any chemical species in the curable liquid that, upon absorbing one or more wavelengths of light, initiates the cross-linking of the cross-linkable monomers and/or oligomers. For example, upon absorption of light, the photo-initiator may produce free radicals, thereby inducing polymerization of the cross-linkable compounds (monomers, oligomers or (pre)polymers) of the curable liquid. The photo-initiator is typically present in an amount less than about 15 wt %, less than about 10 wt %, typically about 1-10 wt %, about 1-5 wt %, or about 2-5 wt %.

Photo-initiators can include, but are not limited to benzophenone and substituted benzophenones; 1-hydroxycyclohexyl phenyl ketone; thioxanthones such as isopropylthioxanthone; 2-hydroxy-2-methyl-1-phenylpropan-1-one, 2-benzyl-2-dimethylamino-(4-morpholinophenyl)butan-1-one, benzil dimethylketal, bis(2,6-dimethylbenzoyl)-2,4,4-trimethylpentylphosphine oxide, 2,4,6-trimethylbenzoyldiphenylphosphine oxide, 2-methyl-1-[4-(methylthio)phenyl]-2-morpholinopropan-1-one, 2,2-dimethoxy-1,2-diphenylethan-1-one or 5,7-diiodo-3-butoxy-6-fluorone.

Commercially available photo-initiators include Omnirad 1000; Omnirad 73, Omnirad 481, Omnirad 248, Omnirad TPO, Omnirad 4817, Omnirad 4-PBZ and PHOTOMER® 4967 from IGM RESINS; Irgacure 184, Irgacure 500, Irgacure 907, Irgacure 369, Irgacure 379, Irgacure 127, Irgacure 1700, Irgacure 651, Irgacure 819, Irgacure 1000, Irgacure 1300, Irgacure 1870, Darocur 1173, Darocur 2959, Darocur 4265 and Darocur ITX available from CIBA SPECIALTY CHEMICALS; Lucerin TPO available from BASF AG; Esacure KT046, Esacure KIP150, Esacure KT37 and Esacure EDB available from LAMBERTI; H-Nu 470 and H-Nu 470X available from SPECTRA GROUP Ltd.; Genopol TX-1 from Rahn AG; and combinations thereof.

The curable liquid may contain one or more polymerization inhibitors to control the rate of polymerization and/or prevent random polymerization. Typical polymerization inhibitors include antioxidants such as phenolic antioxidants, alkylated diphenylamines, phenyl-α-naphthylamines, phenyl-β-naphthylamines, and alkylated α-naphthylamines. The polymerization inhibitors can be present at an amount less than about 5 wt %, less than about 2.5 wt %, less than about 2 wt %, or less than about 1 wt %.

The curable liquid can contain one or more nanoparticles. In some embodiments, the curable liquid can contain two, three, four, or more different nanoparticles. The nanoparticles can be organic nanoparticles or inorganic nanoparticles, e.g. the nanoparticles can be polymeric nanoparticles, metal nanoparticles, metal-oxide nanoparticles, or other nanoparticles. The nanoparticles can have any dimension necessary to achieve the desired properties. In some embodiments the nanoparticles have a greatest dimension from about 10-1,000 nm, about 10-800 nm, about 10-600 nm, about 10-500 nm, about 15-500 nm, about 15-400 nm, about 15-300 nm, about 15-200 nm, about 15-150 nm, about 20-120 nm, about 20-100 nm, or about 20-80 nm. In various aspects the nanoparticles can be less than 100 nm. The nanoparticles can be present in an amount of about 1-25 wt %, about 1-20 wt %, about 1-15 wt %, about 2-15 wt %, about 2-12 wt %, or about 2-10 wt %. The curable liquid can contain one or more organic nanoparticles. The organic nanoparticles can include one or more carbon nanostructures such as carbon nanotubes, fullerenes, graphene, or polyaniline.

The curable liquid can include one or more inorganic nanoparticles. The curable liquid can contain one or more high refractive index inorganic nanoparticles, e.g. TiO₂, ZrO₂, amorphous silicon, PbS, or ZnS nanoparticles. The curable liquid can contain nanoparticles containing one or more metals (e.g., copper, silver, gold, iron, nickel, cobalt, indium, tin, or zinc) and/or metal compounds (e.g., metal oxides, metal chalcogenides, or metal hydroxides). Examples of the metal oxides include, but are not limited to, indium oxide, tungsten oxide, tin oxide, indium tin oxide (ITO), or zinc tin oxide (ZTO). In another embodiment, the nanoparticles can be made from one or more semiconductor materials. Examples of such semiconductor materials include, but are not limited to, silicon, silicon carbide, gallium arsenide, or indium phosphide. In some embodiments the nanoparticles include electronically conductive nanoparticles such as carbon nanotubes, fullerenes, or graphene; metal nanoparticles such as copper or silver nanoparticles; and metal oxide nanoparticles such as ITO and ZTO nanoparticles.

Printed Composite Materials

The methods described herein can be used to produce a variety of composite materials having precisely-controlled properties. In various aspects, multiple properties can be precisely controlled by printing with 2, 3, 4, or more different curable liquids, e.g. having different properties that can be used to precisely control the properties of the composite material.

The composite materials can be structural materials, e.g. having a precisely defined tensile strength, Young's modulus, hardness, elongation at break, or a combination thereof. The structural materials can be printed from a combination of a soft or flexible curable liquid and a hard curable liquid. Examples of structural materials can include polymer composite materials for use in aerospace, or for use in automobiles. Structural materials can include orthopedic devices.

The composite material can be made to have electrical conductivity, e.g. by printing using a conductive curable liquid. The composite material can include, for example, a circuit board having conductive paths or interconnects that are printed into the composite material.

The composite material can be made to be flame retardant, e.g. by printing with a flame retardant curable liquid. The flame retardant properties can be added, for example, to a structural material. Such composite materials can be used, for example, in aerospace and automotive applications.

### EXAMPLES

### Example 1

An exemplary composite material was prepared by printing a rigid curable liquid 20 wt % 2-(2-Vinyloxyethoxy) ethyl acrylate, 30 wt % Photomer 4810, 10 wt % Photomer 4149, 4 wt % Omnirad ITX, 30 wt % Photomer4017 and 6 wt % Photomer 4967 and a flexible curable liquid with 30 wt % 2-(2-Vinyloxyethoxy) ethyl acrylate, 25 wt % SR339, 15 wt % Genomer 1122, 20 wt % 3-Acryloxypropyl trimethoxysilane, 3 wt % Omnirad ITX and 5 wt % Photomer 4967 to form a composite material having specifically controlled properties such as tensile strength and elongation at break. FIGS. 4A-4C depict the different printing configurations, with the rigid material labeled as (A) and the flexible material labeled as (B). In FIG. 4A, the layer was printed as a sandwich structure having the flexible material sandwiched between the rigid material. This configuration is referenced as Sandwich 1. In FIG. 4B, the layer was printed as a sandwich structure having the rigid material sandwiched between the flexible material. This configuration is referenced as Sandwich 2. FIG. 4C depicts a configuration where the flexible material is overprinted on the rigid material.

The tensile strength and elongation at break of each material was determined using an Instron testing machine (Model 5565) at 25° C., 50% RH with a crosshead speed rate of 30 mm/min for all the materials. The statistical average of the measurements for 5 specimens was taken to obtain a reliable data with appropriate standard deviation. Specimens were printed by Direct Color Systems UV1014 and tested according to ASTM D638.

TABLE 1
Properties of printed materials from Example 1.

| | Tensile | Elongation | |
|---|---|---|---|
| Sample | Strength | at Break | Comments |
| A | High | Medium | Strong but |
| | | | brittle |
| B | Low | High | Flexible |
| Sandwich 1 | 60% of A | 125% of A | |
| Sandwich 2 | 80% of A | 120% of A | |
| Overprint Nozzle | 45% of A | 130% of A | |
| Count 85% | | | |
| Overprint Nozzle | 55% of A | 150% of A | Best |
| Count 50% | | | elongation |

The amounts of the components in the above composition can be varied. For example, the weight percentage of each component can vary ±5% or less, or ±3% or less, or ±2% or less.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

We claim:

1. A method for additive manufacturing of a composite material having a precisely-controlled property, the method comprising:
(1) printing an amount of a first curable liquid from a first channel of a multichannel piezo head device and an amount of a second curable liquid from a second channel of the multichannel piezo head device to form a layer,
(2) applying a wavelength of light from a light source to the layer to cure the first curable liquid and the second curable liquid; and
(3) repeating steps (1) and (2) to form the composite material, wherein the amount of the first curable liquid and the amount of the second curable liquid in each layer is adjusted to produce the precisely-controlled property of the composite material.

2. The method of claim 1, wherein the first curable liquid is a hard curable liquid and the second curable liquid is a soft curable liquid, and
wherein the precisely-controlled property is the tensile strength, elongation at break, or Young's modulus of the composite material.

3. The method of claim 1, wherein the first curable liquid is a conductive curable liquid and the precisely-controlled property is the conductivity of the composite material.

4. The method of claim 1, wherein the first curable liquid is a thermally insulating curable liquid and the precisely-controlled property is the thermal insulation of the composite material.

5. The method of claim 1, wherein the first curable liquid is a detectable curable liquid and the precisely-controlled property is the tagging of the composite material.

6. The method of claim 1, wherein the first curable liquid is a flame-retardant curable liquid and the precisely-controlled property is the flame retardancy of the composite material.

7. The method of claim 1, wherein the layer comprises about 30-70 wt % of the first curable liquid and about 30-70% of the second curable liquid based upon the weight of the layer.

8. The method of claim 1, wherein the ratio of the amount of the first curable liquid to the amount of the second curable liquid varies across the layer.

9. The method of claim 1, wherein the layer comprises a sandwich structure of the first curable liquid and the second curable liquid.

10. The method of claim 1, wherein the layer comprises a first portion consisting of the first curable liquid adjacent to a second portion consisting of the second curable liquid.

11. The method of claim 1, wherein step (1) comprises printing a layer of the first curable liquid and an overprinting of the second curable liquid with an overprint nozzle count of about 30% to about 85%.

12. The method of claim 1, wherein step (1) comprises printing a pattern of the first curable liquid and the second curable liquid in the layer,
wherein the pattern in adjacent layers forms a 3-dimensional network of the first curable liquid and the second curable liquid to produce the precisely-controlled property of the composite material.

13. The method of claim 1, wherein the first curable liquid, the second curable liquid, or both comprise a nanoparticle.

14. The method of claim 13, wherein the nanoparticle is selected from the group consisting of a carbon nanotube, a fullerene, a graphene nanoparticle, a polyaniline nanoparticle, a metal nanoparticle, a metal oxide nanoparticle, a metal chalcogenide nanoparticle, a metal hydroxide nanoparticle, a semiconductor nanoparticle, and a combination thereof.

15. The method of claim 1, wherein the first curable liquid, the second curable liquid, or both comprise one or more cross-linkable monomers or oligomers and a photo-initiator.

16. The method of claim 15, wherein the cross-linkable monomers or oligomers in the first curable liquid are present in a combined amount from about 70-98 wt % based upon the total weight of the first curable liquid.

17. The method of claim 15, wherein the photo-initiator in the first curable liquid is present in an amount from about 1-5 wt % based upon the total weight of the first curable liquid.

18. A composite material formed by additive manufacturing according to claim 1.

19. The composite material of claim 18, wherein the first curable liquid is a hard curable liquid and the second curable liquid is a soft curable liquid, and
wherein the material is a structural material having a precisely-controlled tensile strength, elongation at break, or Young's modulus.
